(19) United States
(12) Patent Application Publication
(10) Pub. No.: US 2015/0208060 A1
(43) Pub. Date: Jul. 23, 2015

(54) APPARATUS AND METHOD FOR INPUTTING AND OUTPUTTING STEREO LIGHT FIELD SUPPORTING GENERATION OF EYE'S MOVED POINT OF SIGHT

(71) Applicant: Electronics and Telecommunications Research Institute, Daejeon (KR)

(72) Inventors: Do Hyung KIM, Cheongju-si Chungcheongbuk-do (KR); Il Kyu PARK, Daejeon (KR); Seong Jin PARK, Daejeon (KR); Bon Ki KOO, Daejeon (KR); Jin Sung CHOI, Daejeon (KR)

(21) Appl. No.: 14/604,120

(22) Filed: Jan. 23, 2015

(30) Foreign Application Priority Data
Jan. 23, 2014 (KR) 10-2014-0008256

(51) Int. Cl. H04N 13/02; G06F 3/01; H04N 13/04

(52) U.S. Cl. CPC H04N 13/0278; H04N 13/0484; G06F 3/013; H04N 13/0282; H04N 2013/0465; H04N 2213/007; H04N 2213/008

(57) ABSTRACT

Provided are an apparatus and method for inputting and outputting a stereo light field supporting generation of an eye's moved point of sight. The apparatus includes an image acquisition unit configured to acquire light field data of an object and transmit the acquired light field data, and an image output unit configured to receive the light field data transmitted by the image acquisition unit, generate images according to the points of sight of a viewer's both eyes using the received light field data, and output the generated images.

### CROSS-REFERENCE TO RELATED APPLICATION

This application claims priority to and the benefit of Korean Patent Application No. 10-2014-0008256, filed on Jan. 23, 2014, the disclosure of which is incorporated herein by reference in its entirety.

### BACKGROUND

1. Field of the Invention

The present invention relates to an apparatus and method for inputting and outputting a stereo light field, and more particularly, to an apparatus and method for inputting and outputting a stereo light field which support generation of an eye's moved point of sight.

2. Discussion of Related Art

According to a related art for providing a user with a three-dimensional (3D) effect, a consumer 3D television (TV) provides only one fixed point of sight, and a user comes in a set point-of-sight range and views a stereoscopic image. Also, a multi-view 3D TV provides several points of sight, and provides 3D effects according to the previously set positions.

According to the related art, a user should be positioned in a previously designed area and direction of a device to see an image corresponding to a previously defined point of sight, and thus cannot be provided with a 3D effect when the user moves his or her eyes or turns his or her head.

Research is underway on technology for a consumer 3D TV, a head mounted display (HMD) put on a user's head, or a glasses-type wearable device to provide a user with a 3D effect by tracking the user's head position or the directions of the user's eyes and generating an image according to the corresponding direction.

According to such related art, a mere pseudo image can be artificially generated from an actual image that has already been taken with a single camera or a stereo camera through computer calculation and provided to a user, and it is not possible to generate an optical image corresponding to a direction in which a user's eyes are directed.

Therefore, there is a need to develop technology for playing not a computer graphic image but a previously-taken actual image capable of providing a user with a 3D effect and the sense of reality.

### SUMMARY OF THE INVENTION

The present invention is directed to providing an apparatus and method for inputting and outputting a stereo light field which support generation of points of sight in virtual reality (VR), augmented reality (AR), and stereoscopic content according to movement of a viewer's eyes.

According to an aspect of the present invention, there is provided an apparatus for inputting and outputting a stereo light field supporting generation of an eye's moved point of sight, the apparatus including: an image acquisition unit configured to acquire light field data of an object and transmit the acquired light field data; and an image output unit configured to receive the light field data transmitted by the image acquisition unit, generate images according to points of sight of a viewer's both eyes using the received light field data, and output the generated images.

According to another aspect of the present invention, there is provided an apparatus for inputting and outputting a stereo light field supporting generation of an eye's moved point of sight, the apparatus including: an image acquisition unit configured to acquire light field data of an object using at least one of a plurality of light field camera arrays and light field sensors arranged in a stereo configuration, and transmit the acquired light field data; and an image output unit configured to receive the light field data transmitted by the image acquisition unit, implement an integral image using the received light field data, and output the implemented integral image.

According to still another aspect of the present invention, there is provided a method of inputting and outputting a stereo light field supporting generation of an eye's moved point of sight, the method including: receiving light field data of an object acquired at a position corresponding to a viewer's sight; and generating images using the received light field data according to points of sight of the viewer's both eyes, and outputting the generated images.

According to yet another aspect of the present invention, there is provided a method of inputting and outputting a stereo light field supporting generation of an eye's moved point of sight, the method including: receiving light field data of an object acquired at a position corresponding to a viewer's sight; and implementing an integral image using the received light field data, and outputting the implemented integral image.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a block diagram of an apparatus for inputting and outputting a stereo light field supporting generation of an eye's moved point of sight according to an exemplary embodiment of the present invention;

FIG. 2 is a conceptual diagram showing stereo arrangements of light field camera arrays and light field sensors according to an exemplary embodiment of the present invention;

FIG. 3 is a conceptual diagram illustrating implementation of an integral image by an apparatus for inputting and outputting a stereo light field supporting generation of an eye's moved point of sight according to an exemplary embodiment of the present invention;

FIG. 4 shows conceptual diagrams of application examples of an apparatus for inputting and outputting a stereo light field supporting generation of an eye's moved point of sight according to an exemplary embodiment of the present invention; and

FIG. 5 is a flowchart of a method of inputting and outputting a stereo light field supporting generation of an eye's moved point of sight according to an exemplary embodiment of the present invention.

### DETAILED DESCRIPTION OF EXEMPLARY EMBODIMENTS

Exemplary embodiments of the present invention will now be described more fully with reference to the accompanying drawings to clarify aspects, features, and advantages of the present invention. The invention may, however, be embodied in many different forms and should not be construed as being limited to the embodiments set forth herein. Rather, these embodiments are provided so that this disclosure will be through and complete, and will fully convey the concept of the invention to those of ordinary skill in the art. The present invention is defined by the appended claims.

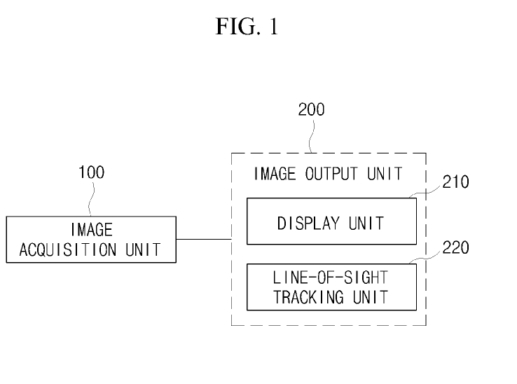

FIG. 1 is a block diagram of an apparatus for inputting and outputting a stereo light field supporting generation of an eye's moved point of sight according to an exemplary embodiment of the present invention.

The apparatus for inputting and outputting a stereo light field supporting generation of an eye's moved point of sight according to the exemplary embodiment of the present invention includes an image acquisition unit 100 that acquires light field data of an object and transmits the acquired light field data, and an image output unit 200 that receives the light field data transmitted by the image acquisition unit 100, generates an image using the received light field data according to the points of sight of a viewer's both eyes, and outputs the generated image.

The image acquisition unit 100 acquires light field data of an object using at least one of a plurality of light field camera arrays 100a and light field sensors 100b.

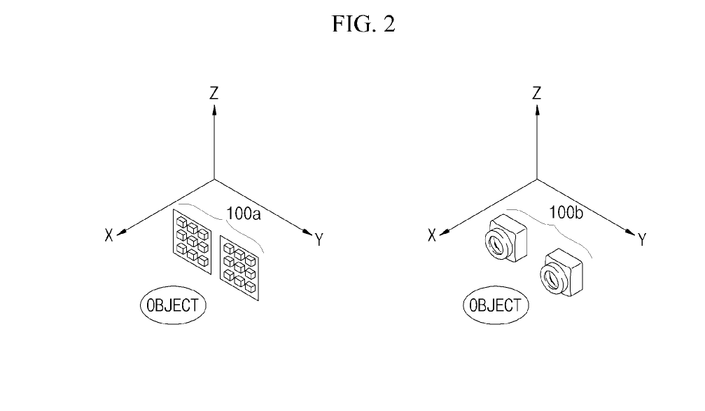

FIG. 2 is a conceptual diagram showing stereo arrangements of light field camera arrays and light field sensors according to an exemplary embodiment of the present invention. The plurality of light field camera arrays 100a and light field sensors 100b are arranged in a stereo configuration, and acquire light field data of an object.

The light field camera arrays 100a and the light field sensors 100b are connected by a support unit having rigidity so that each of the light field camera arrays 100a and the light field sensors 100b may uniformly maintain its disposed position and rotation angle.

As shown in FIG. 2, the light field camera arrays 100a and the light field sensors 100b of the image acquisition unit 100 are arranged in the stereo configuration, acquire light field data (four-dimensional (4D) or five-dimensional (5D) light field data) according to positions corresponding to left and right sights of a viewer's both eyes, and store the acquired data.

A line-of-sight tracking unit 220 included in the image output unit 200 tracks movement of each of the viewer's left and right eyes, thereby tracking a change in the viewer's point-of-sight direction.

A display unit 210 included in the image output unit 200 generates an image to be provided to the viewer using the light field data acquired and stored by the image acquisition unit 100 according to the direction of the viewer's point-of-sight tracked by the line-of-sight tracking unit 220.

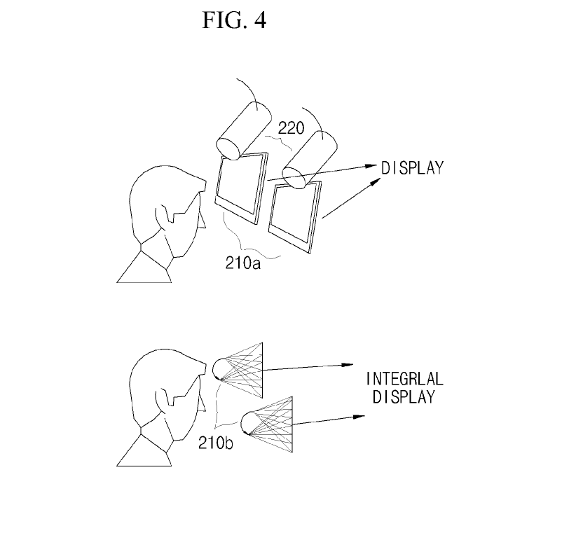

FIG. 4 shows conceptual diagrams of application examples of an apparatus for inputting and outputting a stereo light field supporting generation of an eye's moved point of sight according to an exemplary embodiment of the present invention. As shown in the upper diagram of FIG. 4, the line-of-sight tracking unit 220 tracks a viewer's point-of-sight direction, and the display unit 210a of the image output unit 200 separately outputs images generated based on the viewer's points of sight to the viewer's left and right eyes. The display unit 210a is installed in a wearable device, such as a head mounted display (HMD) or a glasses-type display device, disposed in front of the viewer's both eyes, and separately outputs the generated images to the viewer's left and right eyes.

The apparatus for inputting and outputting a stereo light field supporting generation of an eye's moved point of sight according to the exemplary embodiment of the present invention tracks movement of a viewer's eyes and generates and provides an image optically according with movement of the eyes, thereby providing the viewer with a realistic 3D effect.

An apparatus for inputting and outputting a stereo light field supporting generation of an eye's moved point of sight according to another exemplary embodiment of the present invention includes an image acquisition unit 100 that acquires light field data of an object using at least one of a plurality of light field camera arrays 100a and light field sensors 100b arranged in a stereo configuration and transmits the acquired light field data, and an image output unit 200 that receives the light field data transmitted by the image acquisition unit 100, implements an integral image using the received light field data, and outputs the implemented integral image.

The image acquisition unit 100 stores light field data of an object acquired in a previously set imaging angle range, and the image output unit 200 plays light field data of basic images taken in the previously set imaging angle range by the image acquisition unit 100 in the form of a light wave, thereby providing a glassless integral display (210b).

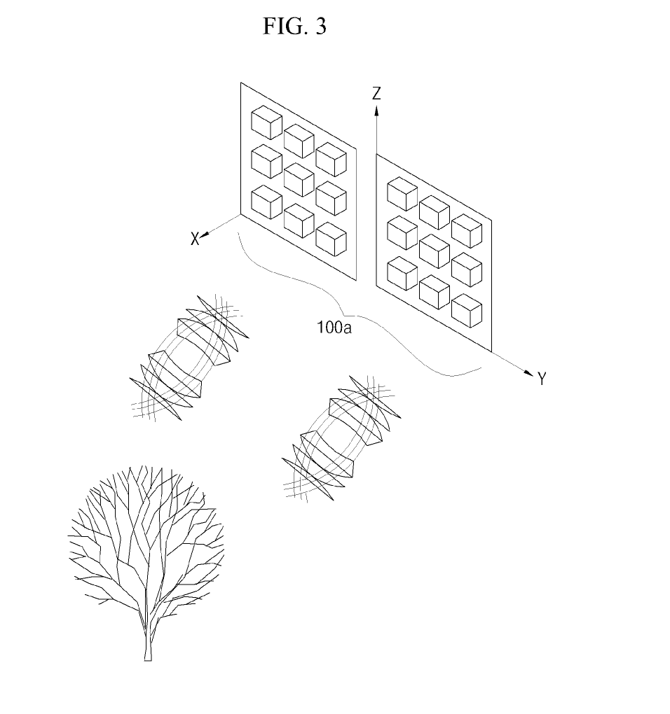

FIG. 3 is a conceptual diagram illustrating a part of a process in which the apparatus for inputting and outputting a stereo light field supporting generation of an eye's moved point of sight according to the other exemplary embodiment of the present invention acquires light field data and implements an integral image, and the lower diagram of FIG. 4 illustrates an application example of the apparatus for inputting and outputting a stereo light field supporting generation of an eye's moved point of sight according to the other exemplary embodiment of the present invention.

An integral image is an autostereoscopic image that is made to be three-dimensionally observed using a lens array without an additional device, such as glasses, and autostereoscopy includes a pickup process and a display process.

In the pickup process, different images obtained by photographing a 3D object in several directions are stored as basic images using a lens array, and in the display process, these basic images are played through the lens array as an original light wave.

An integral image method takes images at various angles using a lens in the form of an insect's compound eyes (a fly's eyes), and plays the images, reducing eyestrain and providing a natural stereoscopic image to a viewer.

A method of inputting and outputting a stereo light field supporting generation of an eye's moved point of sight according to an exemplary embodiment of the present invention includes an operation of receiving light field data of an object acquired at a position corresponding to a viewer's sight, and an operation of generating images using the received light field data according to the points of sight of the viewer's both eyes, and outputting the generated images.

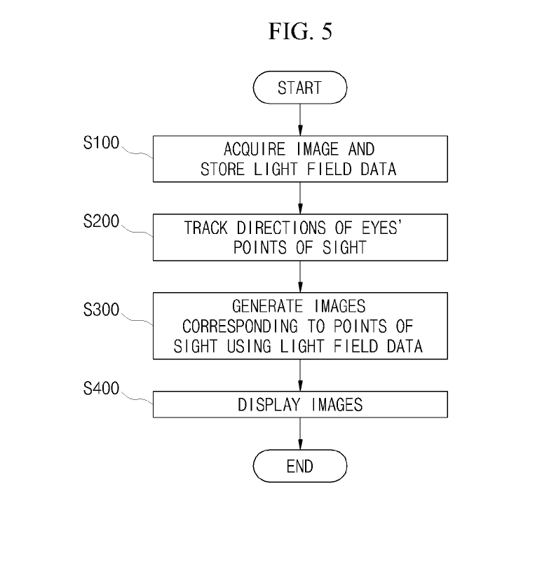

FIG. 5 is a flowchart of a method of inputting and outputting a stereo light field supporting generation of an eye's moved point of sight according to an exemplary embodiment of the present invention. The method includes an operation of receiving and storing light field data of an object acquired by at least one of a plurality of light field camera arrays and light field sensors arranged in a stereo configuration (S100), an operation of tracking movement of each of a viewer's left and right eyes to track the directions of the viewer's points of sight (S200), an operation of separately generating images corresponding to the points of sight of the left and right eyes using the light field data according to the tracked directions of the viewer's points of sight (S300), and an operation of displaying the generated images (S400).

In the operation of storing the light field data (S100), light field data stored by at least one of the plurality of light field camera arrays and the light field sensors arranged in the stereo configuration at a position corresponding to the viewer's sight is received and stored.

In the operation of displaying the generated images (S400), the images separately generated for the points of sight of the left and right eyes are output to the viewer's left and right eyes using a wearable device, such as an HMD or a glasses-type display device.

A method of inputting and outputting a stereo light field supporting generation of an eye's moved point of sight according to another exemplary embodiment of the present invention includes an operation of receiving light field data of an object acquired at a position corresponding to a viewer's sight, and an operation of implementing an integral image using the received light field data, and outputting the implemented integral image.

In the operation of storing the light field data (S100), light field data acquired using at least one of a plurality of rotatable light field camera arrays and rotatable light field sensors arranged in the a stereo configuration is received.

In the operation of outputting the integral image (S400), the light field data is played in the form of a light wave to implement the integral image, and the implemented integral image is output using a glassless display method.

By generating and implementing an integral image, it is possible to provide all images corresponding to the directions of a user's eyes, and thus the operation of tracking movement of the eyes (S200) and the operation of generating images corresponding to the points of sight of the eyes (S300) are omitted.

An apparatus and method for inputting and outputting a stereo light field which support generation of an eye's moved point of sight according to exemplary embodiments of the present invention provide point-of-sight images corresponding to the directions of a viewer's eyes when playing a previously-taken actual image without using a computer graphic image. Therefore, the viewer is provided with a 3D effect, the sense of reality, and a high degree of freedom.

In addition, the apparatus and method according to exemplary embodiments of the present invention provide an image optically according with movement of eyes based on an actual image of an object, thereby providing realistic bidirectional sensory interaction and a 3D effect.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An apparatus for inputting and outputting a stereo light field supporting generation of an eye's moved point of sight, the apparatus comprising:
an image acquisition unit configured to acquire light field data of an object and transmit the acquired light field data; and
an image output unit configured to receive the light field data transmitted by the image acquisition unit, generate images according to points of sight of a viewer's both eyes using the received light field data, and output the generated images.

2. The apparatus of claim 1, wherein the image acquisition unit acquires the light field data of the object using at least one of a plurality of light field camera arrays and light field sensors arranged in a stereo configuration.

3. The apparatus of claim 2, further comprising a support unit configured to maintain a position and a rotation angle of at least one of the plurality of light field camera arrays and light field sensors in previously set ranges.

4. The apparatus of claim 2, wherein the image acquisition unit is arranged in the stereo configuration and stores the light field data according to positions corresponding to left and right sights of the both eyes.

5. The apparatus of claim 1, wherein the image output unit tracks directions of the viewer's points of sight by tracking movement of each of the viewer's left and right eyes.

6. The apparatus of claim 5, wherein the image output unit generates the images using the light field data according to a result of tracking the directions of the viewer's points of sight.

7. The apparatus of claim 6, wherein the image output unit separately outputs the images generated based on the viewer's points of sight to the viewer's left and right eyes.

8. The apparatus of claim 7, wherein the image output unit is installed in at least one of a head mounted display (HMD) and a glasses-type display device to be disposed in front of the viewer's both eyes, and separately outputs the generated images to the viewer's left and right eyes.

9. An apparatus for inputting and outputting a stereo light field supporting generation of an eye's moved point of sight, the apparatus comprising:
an image acquisition unit configured to acquire light field data of an object using at least one of a plurality of light field camera arrays and light field sensors arranged in a stereo configuration, and transmit the acquired light field data; and
an image output unit configured to receive the light field data transmitted by the image acquisition unit, implement an integral image using the received light field data, and output the implemented integral image.

10. The apparatus of claim 9, wherein the image acquisition unit stores the light field data of the object acquired in a previously set imaging angle range.

11. The apparatus of claim 10, wherein the image output unit plays the light field data of basic images taken in the previously set imaging angle range by the image acquisition unit in a form of a light wave using a lens array to provide a glassless display.

12. A method of inputting and outputting a stereo light field supporting generation of an eye's moved point of sight, the method comprising:
receiving light field data of an object acquired at a position corresponding to a viewer's sight; and
generating images using the received light field data according to points of sight of the viewer's both eyes, and outputting the generated images.

13. The method of claim 12, wherein the receiving of the light field data includes receiving the light field data of the object acquired by at least one of a plurality of light field camera arrays and light field sensors arranged in a stereo configuration.

14. The method of claim 13, wherein the receiving of the light field data includes receiving the light field data stored at the position corresponding to the viewer's sight by at least one of the plurality of light field camera arrays and light field sensors arranged in the stereo configuration.

15. The method of claim 12, further comprising tracking movement of the viewer's left and right eyes to track directions of the viewer's points of sight.

16. The method of claim 15, further comprising separately generating images corresponding to the points of sight of the left and right eyes using the light field data according to the tracked directions of the viewer's points of sight.

17. The method of claim 16, wherein the outputting of the generated images includes outputting the separately generated images corresponding to the points of sight of the left and right eyes to the viewer's left and right eyes using a glasses-type display device.

18. A method of inputting and outputting a stereo light field supporting generation of an eye's moved point of sight, the method comprising:
receiving light field data of an object acquired at a position corresponding to a viewer's sight; and
implementing an integral image using the received light field data, and outputting the implemented integral image.

19. The method of claim 18, wherein the receiving of the light field data includes receiving the light field data acquired using at least one of a plurality of rotatable light field camera arrays and rotatable light field sensors arranged in a stereo configuration.

20. The method of claim 19, wherein the outputting of the implemented integral image includes playing the light field data in a form of a light wave to implement the integral image, and outputting the implemented integral image using a glassless display method.
